(19) United States
(12) Patent Application Publication
(10) Pub. No.: US 2025/0083276 A1
(43) Pub. Date: Mar. 13, 2025

(54) PROCESSING MANAGEMENT SYSTEM AND METHOD FOR PROCESSING A COMPLETE TOOL COMPRISING A TOOL HOLDER AND A TOOL

(71) Applicant: Franz Haimer Maschinenbau KG, Hollenbach-Igenhausen (DE)

(72) Inventor: Andreas Haimer, Hollenbach-Igenhausen (DE)

(21) Appl. No.: 18/883,044

(22) Filed: Sep. 12, 2024

(30) Foreign Application Priority Data
Sep. 12, 2023 (DE) 10 2023 124 591.0
Sep. 29, 2023 (DE) 10 2023 126 747.7
Aug. 1, 2024 (DE) 10 2024 122 026.0

(51) Int. Cl. B23Q 17/09; B23Q 3/157; B23Q 17/22

(52) U.S. Cl. CPC B23Q 17/0995; B23Q 3/157; B23Q 17/225

(57) ABSTRACT

The method for data exchange during control of processing of a complete tool, which includes a tool holder and a tool, in an integrated/linked processing environment with at least one instrument for mounting the tool into the tool holder and/or a balancing instrument and/or a presetting instrument provides that a superordinate manufacturing planning/control for manufacturing a component communicates processing data for processing the complete tool, in particular a tool list and/or device sheets, to a processing management system. The processing management system then communicates work instructions/data ascertained using the processing data to the instruments of the integrated/linked processing environment.

### CROSS-REFERENCE TO RELATED APPLICATION

This application claims the priority, under 35 U.S.C. § 119, of German Patent Applications DE 10 2023 124 591.0, filed Sep. 12, 2023, DE 10 2023 126 747.7, filed Sep. 29, 2023, and DE 10 2024 122 026.0, filed Aug. 1, 2024; the prior applications are herewith incorporated by reference in their entirety.

### FIELD AND BACKGROUND OF THE INVENTION

The invention relates to a method for data exchange during the control of a processing operation of a complete tool comprising a tool holder and a tool in an integrated/linked or networked processing environment, and a processing management system and also an apparatus/a system for data processing, a computer program, a computer program product, and a computer-readable (storage) medium.

In the context of automated and/or digitized manufacturing processes (Industry 4.0) during the manufacture of components, it is known to use integrated or networked manufacturing environments with integrated/linked instruments, such as machine tools and other manufacturing instruments.

In this case, the instruments integrated in such manufacturing environments—in the context of control therein—communicate with one another via—usually defined—interfaces, important data for processes—implemented on the instruments. In other words, processing data are exchanged or transferred.

During a manufacturing process in component manufacture, as also known, the process for manufacturing the components is effected by means of so-called complete tools, a term understood to mean a tool holder, for example a clamping chuck, such as a shrink fit chuck, and also a tool inserted in such a tool holder or held clamped there, for example a rotary tool, such as a milling tool. That is, a complete tool is a tool holder with a tool.

If component manufacture is effected by means of a machine tool, such as a CNC (milling) machine, using such a complete tool, and wear occurs on the tool during component manufacture, then this necessitates mounting of the complete tool or exchange of a tool in the complete tool.

For this purpose, known instruments are available, such as in particular mounting instruments (for mounting tools in tool holders), for example shrink fit instruments, and thus they too are/can be part of the integrated or networked (component) manufacturing environment.

A degree of automation of such manufacturing environments, and also quality of components manufactured in such manufacturing environments, is crucially dependent on how well the processes in such a manufacturing environment can be coordinated, monitored and controlled, in particular also what data are available—and also how well and reliably data are available at the individual instruments.

### SUMMARY OF THE INVENTION

It is a first object of the invention to make it possible to increase a degree of automation during component manufacture, in particular also in conjunction with high manufacturing efficiency and effectiveness. Moreover, it is an object of the invention to make it possible for component manufacture to be able to be implemented with high accuracy but also speed.

This first object of the invention is achieved by a method for data exchange during control of processing of a complete tool comprising a tool holder and a tool, and a processing management system and also an apparatus/system for data processing, a computer program [product] and a computer-readable (storage) medium having the features of the respective independent claim.

Advantageous developments of the invention related to the first object are the subject matter of dependent claims and of the following description, and relate both to the method and to the system, the apparatus/system, the computer program, the computer program product, and the computer-readable (storage) medium.

Any relative terms that are used, such as top, bottom, front, rear, left or right—unless explicitly defined otherwise, should be understood in the usual way, including with regard to the present figures. Terms, such as radial and axial, where used and not explicitly defined otherwise, should be understood in relation to center axes, or axes of symmetry, of component parts/components described here, including with regard to the present figures.

The term “substantially” may, in accordance with the prevailing caselaw, be understood to mean “to a practically still significant degree.” Possible deviations from exactness that are thus implied by this concept may thus arise unintentionally, that is to say without any functional basis, owing to manufacturing or assembly tolerances or the like.

The method for data exchange during control of processing of a complete tool comprising a tool holder and a tool in an integrated/linked or networked processing environment with at least one instrument for mounting the tool into the tool holder and/or a balancing instrument and/or a presetting instrument provides that in particular a superordinate manufacturing planning/control for manufacturing a component communicates processing data for processing the complete tool, in particular a tool list and/or device sheets, to a processing management system.

The processing management system then communicates work instructions/data ascertained using the processing data to the instruments of the integrated/linked or networked processing environment.

The processing management system for data exchange during control of processing of a complete tool comprising a tool holder and a tool in an integrated/linked or networked processing environment with at least one instrument for mounting the tool into the tool holder and/or a balancing instrument and/or a presetting instrument is configured in such a way that using processing data for processing the complete tool, in particular a tool list and/or device sheets, communicated in particular by a superordinate manufacturing planning/control for manufacturing a component, work instructions/data are ascertainable and these work instructions/data are communicable to the instruments of the integrated/linked or networked processing environment.

The method and the processing management system are in particular realized in the context of a, in particular automated and/or digitized, processing process in the case of the complete tool—and manufacturing process for manufacturing a component using a or the complete tool—with optionally further machines and automation components, such as for example machine tools, of or in an integrated or networked processing environment or manufacturing environment.

Instead of manufacturing processes of the manufacturing environment, there may also be processes of other (process) environments, such as for example of complete tool inventory management, here for example with (digitized) Kanban processes (by which a pool of the complete tools/tools is continuously kept at a specific level), which communicate with the method and the processing management system, in particular in the context of push and/or pull messages exchanged with the processing management system. To put it another way, here processing data come (or originate and/or optionally proceed) from such other (process) environments (optionally in the context of “push” or “pull”)—or—to put it even more succinctly—other environments take the place of the manufacturing environment.

In this case, the terms “integrated” and “networked” mean in particular that items of information, data and the like can be exchanged between “integrated”/“networked” units. In the sense of digital integration/networking, as also meant here, in particular digital data can thus also be exchanged between the units. This is generally done via (standardized, defined) interfaces (at the instruments).

Put simply and clearly, the (integrated or networked) manufacturing environment comprises the entire process of component manufacture—and can thus also—by way of a/the superordinate manufacturing planning/control for manufacturing a component (in this manufacturing environment) (—accordingly also other (process) environments by way of superordinate units therein)—make available the processing data (for processing the complete tool for manufacturing the component—or for other processes); the integrated/linked processing environment comprises the creation of the complete tool—and is integrated, in particular functionally, in the manufacturing environment or other environments—and thus there (by means of the processing management system) using the processing data can then generate/create work instructions/data and communicate them to the instruments of the integrated/linked processing environment.

Moreover, the “superordinate” environment, as mentioned, can be a different environment, for example a complete tool inventory management which makes the processing data available. To put it another way, the processing data can thus also come—for example—from a Kanban process which for example continuously keeps a pool of the complete tools/tools at a specific level.

Furthermore, the processing data can be communicated—also bidirectionally—in the form of push and/or pull messages; in particular, the processing data can thus be present in digital form, for example digital tool list and/or device sheets.

In particular, it can thus also be expedient if the processing management system monitors or controls the instruments of the processing environment, in particular using the work instructions/data.

Put simply and clearly, the processing management system is the entity which monitors and/or controls the processing environment or the instruments of the processing environment. The processing management system can thus also realize central management of the processing environment or central networking of the processing environment.

Full automation in the processing environment is realizable as a result.

Such monitoring is also realizable in particular if the processing management system is configured to evaluate data, in particular the work instructions/data and/or data generated by the instruments.

Moreover, by means of the processing management system, data, such as in particular the work instructions/data and also other data, can be exchanged bidirectionally with the processing environment or in the processing environment, in particular of instruments integrated or networked therein. This also makes it possible for the processing environment or the instruments of the processing environment to be able to make e.g. requests and the like directed to the processing management system.

Put simply and clearly, the instruments of the processing environment can give feedback, for example about their states and/or shortcomings, to the processing management system.

The incorporation of the processing management system (then further) “upward” into the manufacturing environment thus enables component manufacture to be fully automated throughout. The same correspondingly applies to incorporation into other environments.

Incorporation here can also mean that data such as in particular the processing data are transferred in the context of a push or pull control.

The invention is based on the consideration that hitherto processes in a (component) manufacturing environment have/had not been integrated fully—“right down” to the provision/creation of complete tools (processing environment)—and processes in this regard (for creating a complete tool) proceed in a “dedicated/separate” environment, the processing environment. At this level, too, i.e. in the processing environment, integration of the components, enabling full automation, had not been realized.

Here therefore (in the processing environment and also at this “processing environment/manufacturing environment” (i.e. “component manufacture/complete tool creation”) interface), a fully automated process throughout component manufacture had not been afforded throughout—and the degree of automation of component manufacture “being all-encompassing, i.e. encompassing all processes” had not been provided.

The invention then transforms this insight into an integrated processing environment (for the creation of a complete tool) which, firstly, itself integrates instruments of the processing environment (for creating the complete tool). Secondly, the invention thus then also opens up the possibility of the (integrated) processing environment also itself being further integrable into the overall environment of component manufacture, i.e. the manufacturing environment.

What is more, although one-to-one allocations/identifications of complete tools or tool holders and their tools throughout the processing environment as well as the manufacturing and processing environment had been difficult or even impossible to realize or sustain—in particular owing to the processes not being applicable throughout—the invention nevertheless now also opens up a one-to-one identification/allocation (cf. hereinafter concerning the “UniqueID”) not least in the processing environment, but then in the entire manufacturing environment as well.

By this means, too, it becomes possible for processes in the (manufacturing/processing) environment (down to the lowest levels, e.g. mounting, for example shrink fitting, balancing or presetting—of a specific complete tool) also to become completely monitorable and controllable anywhere and at any time—and thus for full automation to be realizable—in the processing environment as well as in a (overall) manufacturing environment.

To put it another way, the allocation of a one-to-one identification (“UniqueID”) for/to a specific complete tool/tool/tool holder (in the processing environment) (“tool entity”) may be essential for (individual) monitoring, tracking, logging of a complete tool in/during processes in the processing environment (as well as then in the manufacturing environment). This in turn is essential for full automation.

If the one-to-one identification (“UniqueID”) is allocated to a digital twin of a complete tool/tool/tool holder, i.e. if a type or type identification can also be specifically individualized—for a specific complete tool/tool/tool holder—or broken down to this, then a large number of “sister tools” can be individually created on the basis of the (digital) device sheet (or digital twin) with one-to-one identification (“UniqueID”) together with specific tool and geometry data.

Such one-to-one identification can be applied on a specific complete tool/tool/tool holder, in particular by laser treatment—and can thus be read there at anytime and anywhere.

It is then possible, by way of example, to log and count each mounting process/shrink fitting process in the case of a complete tool—with such an allocated one-to-one identification—(for this complete tool) “with respect to this” one-to-one identification. By way of a reporting mechanism, it is then possible for example to query the number of mounting cycles/shrink fitting cycles—and, upon fixed limits being reached, to display warnings in order to be able to exchange the tool holder of the complete tool—before an age limit is reached. In the same way, the state of a tool can be logged if it still has a remaining service life for example after a production order has been processed.

Moreover, by means of such a one-to-one identification (“UniquID”) in the case of a complete tool, it is possible to warn against the improper handling thereof and/or an incorrect process treatment in the case of this complete tool (in particular in the processing environment). In this regard, for example, if the one-to-one identification (“UniquID”) in the case of a complete tool or tool holder is read or scanned—and this is thus recognized (one-to-one)—here for example as a tool holder that ought not to undergo shrink fitting, such as a hydro-expansion chuck or a collet receptacle, it is possible to issue a warning which warns against the shrink fitting of the complete tool or the tool holder.

Furthermore, this one-to-one identification or complete tools/tools/tool holders identified by the one-to-one identification can be assigned characteristic values with the aid of which specific dimensions can be complied with during mounting of the complete tool/shrink fitting.

Once all components of a complete tool, for example tool holder, tool extension and actual tool (for example miller) in the case of a complete tool have thus also been designated with the one-to-one identification or the unique ID, then the processing management system can thereby produce/document an association of these components with the complete tool—and thus make available a compilation, an assembly and the like (in particular to a user).

The apparatus/the system, the computer program [product] and the computer-readable (storage) medium are configured to execute the method according to the invention/the steps of the method according to the invention and the processing management (and also the developments and configurations thereof).

Various configurations are exemplary or advantageous. In this regard, the tool can be a turning tool or in particular a rotary tool, such as for example a milling tool (miller for short), a drill or the like. The tool holder can be a clamping chuck, such as a shrink fit chuck/receptacle or else a collet receptacle, a hydro-expansion chuck, a Weldon receptacle, a face mill arbor or a turning plate holder. The instrument for mounting the tool into the tool holder, mounting instrument for short, can thus be in particular a shrink fit instrument—or some other corresponding (mounting) instrument (for other tool chucks mentioned by way of example, i.e. e.g. a mounting station with an apparatus for receiving the tool holder together with digital display and feedback to the processing management system and/or to a length measuring device).

Moreover, in the integrated/linked processing environment—besides the instruments mentioned—it is also possible to integrate/link further instruments, apparatuses, and/or installations, such as for example a cleaning station or a preserving station, as well as management solutions/management systems, such as for example in particular also tool/tool management solutions, tool dispensing systems/tool return systems, inventory management systems, data management systems, in particular also for tool data, tool holder data, manufacturing data, processing data, e.g. shrink fitting and/or balancing parameters, allowance (i.e. a value to be taken into account during shrink fitting to length in order to attain the desired target dimension more accurately after cooling), weight, A-dimension of the chuck and the like (all of which are also referred to for short just as “instruments” for simplification).

Furthermore, it is expedient in particular if the (work/processing) data, the work instructions and other items of information or data are digital. In particular, the tool lists and/or the device sheets are thus also digital.

In particular, it is expedient and advantageous for the processing management to be networked/linked or caused to communicate with a central database—or for such a central database to be integrated into the processing management system.

Moreover, it is expedient if in particular the processing management system is configured to evaluate data, in particular the work instructions/data and/or data generated by the instruments.

Moreover, in the processing environment, in particular in the case of the instruments of the processing environment, individual databases can be realized which in particular can be synchronized—and thus iteratively complement one another.

In particular tool data, tool holder data, processing data, such as in particular shrink fitting and balancing and/or presetting parameters, can be stored there or storable there. These can be “enriched” by user data and time stamps—for tools/tool holders/complete tools—in order that instances of incorrect operator control are identifiable in a simple manner by a fully integrated overview of the processes and possible instances of incorrect mounting. Complete tool management can thus also be made available by way of these data.

In this case, it can furthermore be expedient if stored data, in particular stored tool data—and hence tools, are groupable, for example by means of allocatable “labels”, “stamps”- or other in particular digital markings, or TAGs.

For example, it can be possible for—including over a plurality of levels—tools to be grouped, for example also in lists. Grouping categories can be for example specific machines, specific locations, specific processings, specific projects and the like.

Moreover, any other documentation, such as for example also (or in the form of) photographs, drawings, images and the like, concerning tools/tool holders/complete tools, can be stored in particular in the database.

User management or feedback can also be set up in the case of the processing management system or by way of data therein. Users registered for instruments or their registration/login data/credentials can be stored in order thus to be documented (and evaluable) in histories.

In this regard, it can furthermore also be beneficial if the processing management system allows an identification and/or login of users (in the system and/or on instruments)—for example by way of codes, readable data carriers, such as optionally RFID cards/tags, or the like and/or biometric data.

Furthermore, here it can then also be expedient if the processing management system allows reading from and in particular also writing to data carriers (which are used in particular on the instruments in the processing environment). For example, it is thus beneficial if data carriers on tools, such as for example Balluff chips (on tool holders), are writable/readable—by or at the processing management system. In this case, here in particular it is also beneficial if these are compatible with the instruments (of the processing environment).

Everything of the sort can for example then be evaluated, for example by AI and/or image processing and/or “machine learning”—in order for example to analyze cutting edges/cutting edge geometries—for example with regard to the wear thereof.

If histories are thus documented and/or evaluated, then changes and/or comparisons (regarding states at tools/tool holders/complete tools) can be ascertained and/or made—and optionally by this means predictions (concerning tools/tool holders/complete tools, for example wear developments) can also be made (“predictive analysis”).

If such evaluations and/or predictions deviate from predefinitions, for example an analyzed or established cutting edge fracture and/or a deviation of a target/actual service life from the actual pattern, and if appropriate faults should thus be expected, warnings in this regard can be issued.

Further possibilities for evaluating the data obtained, possibly using artificial intelligence (AI):
tracking the wear behavior using images from the presetting instrument or using separately produced images or measurements
assigning the wear behavior/pattern to the implemented processing
recognizing unusual wear patterns
deductions from wear pattern about possible faults in the processing, e.g. unfavorable cut data or problems in tool or workpiece clamping.
proposal therefrom concerning improved cut data or correction of other faults
deductions about properties of the machine tool, e.g. stiffness, susceptibility to vibration

Such artificial intelligence is also the subject matter of our above-mentioned German patent application DE 10 2024 122 026.0, the priority of which is claimed and which is incorporated by reference herein. Details from the prior-filed German application DE 10 2024 122 026.0 are also described hereinafter in the following under the heading DE 10 2024 122 026.0—“Method and Apparatus for Autonomously Measuring a Tool or a Complete Tool”). The features of the prior German application are thus also the subject matter of the present application and can also be combined in any combination with other features of the present application, which yields further subjects according to the application.

Furthermore, it is also expedient if the processing management system or the “data management” thereof allows data import and/or export (import/export function). It is expedient in this case if such data import/export is possible in arbitrary formats. In this regard, for example, lists, catalogs—or else any other compilations of data can be imported and/or exported. This therefore allows data updates and/or data synchronizations in the processing management system.

This all-encompassing data management made possible for the processing management system in particular also the possibility of “assembling” the complete tools (comprising tools and tool holder) from such data—and then also linking them with corresponding processing parameters. Suchlike can then again be part of work instructions/data, whereby then the instruments in the processing environment are or become (centrally) controllable.

Furthermore, it is expedient if using the work instructions/data the instruments of the integrated/linked processing environment are monitored and/or controlled, in particular under remote control by the processing management system. Here it is in particular then also expedient if tools/tool holders/complete tools are encoded with a one-to-one code, such as a one-to-one data matrix code. In this way one-to-one identifications, such as numbers, —or other (then one-to-one) items of information can then be stored/encoded in this code.

Furthermore, the processing management system, in particular by means of its work instructions/data, over and above its processing environment can “influence” the manufacturing environment and/or communicate there, in particular concerning manufacturing machines therein. This made possible for example feedback and/or “connectivity” with respect to machine controllers, including 3D collision monitoring of the physical part of tool/tool holder/complete tool.

Moreover, it can be provided that the work data, in particular those for the mounting instrument, in particular the shrink fit instrument, include at least one of the following items of information, in particular a plurality of the following items of information, in particular all of the following items of information:
type of the tool holder, in particular of the shrink fit chuck, (optionally also article number) and/or storage location of the tool holder, in particular of the shrink fit chuck,
unique identification, in particular number, of the tool holder, in particular of the shrink fit chuck,
type of the tool, in particular of the miller, and/or storage location of the tool, in particular of the miller,
unique identification, in particular number, of the tool, in particular of the miller, in particular in the case where the already used tool, in particular the miller, still has enough remaining running time, and/or of the tool holder, in particular of the shrink fit chuck,
number of identical tools required, in particular depending on a planned unit quantity of a component to be manufactured and a service life of the tool, in particular of the miller, in particular also taking account of a remaining running time in the case of used tools, in particular millers,
target length of the complete tool with tolerances,
allowance (optionally also to be adapted),
number of mounting cycles, in particular shrink fit cycles, of the tool holder, in particular of the shrink fit chuck.

The work instructions, in particular those for the mounting instrument, in particular the shrink fit instrument, can include at least one of the following items of information, in particular a plurality of the following items of information, in particular all of the following items of information:
remove tool holder, in particular shrink fit chuck, and/or tool, in particular miller, in a predefined unit quantity from storage,
reading, in particular scanning, a unique identification, in particular data matrix code and/or number, on/of the tool holder, in particular shrink fit chuck, and/or on/of the tool, in particular the miller,
in particular automatic selection of shrink fit parameters, in particular with an allowance,
display of or of all relevant shrink fit parameters/data,
drive length stop to a predefined or predefinable length, possibly automatically or manually with user guidance on the mounting instrument, in particular on the shrink fit instrument,
display of coarse setting, in particular with color display, in particular red/green,
upon approaching the target dimension, fine display, in particular with color display, in particular with red/green,
heat tool holder, in particular shrink fit chuck,
insert tool, in particular miller,
pivot in length stop,
raise tool, in particular miller, to length stop (manually or with compression spring),
waiting time until tool, in particular miller, is clamped,
cool tool holder, in particular shrink fit chuck,
monitoring of the cooling process,
control actual length with length stop,
storing the actual length in database,
identifying the complete tool with the unique number of the tool holder, in particular of the shrink fit chuck,
in particular as an alternative to shrink fitting for mechanical clamping chucks, an automatic display of tool holder parameters, in particular torque to be used for the in particular collet chuck or hydro-expansion chuck for technically proper mounting and also the associated accessories for turning plate holders such as sliding blocks, mounting apparatuses and the like, and also final representation of the complete tool for confirming the technically proper mounting, in particular together with the length tolerances thereof.

In this case, the information can be the instruction itself or can be part of the instruction or the instruction can be generated from the information.

Furthermore, it can be provided that the work data, in particular those for the presetting instrument, include at least one of the following items of information, in particular a plurality of the following items of information, in particular all of the following items of information:
a piece of geometry information, in particular a total length of the complete tool and/or a diameter of the tool, in particular of the miller, and/or corner radius of the tool, in particular of the miller
a tool service life, in particular in the form of components per new tool or service life in minutes/hours.

Furthermore, it is expedient if the work instructions, in particular those for the presetting instrument, also include at least one of the following items of information, in particular a plurality of the following items of information, in particular all of the following items of information:
insert complete tool in measurement spindle,
optionally starting of an automatic measurement run—or starting of a manual measurement, in particular of predefined variables,
reading actual dimensions into database and/or transmitting actual dimensions to processing management system (or the database thereof),
additionally—transmitting presetting data to processing machines as well.

Furthermore, it is expedient if the work data, in particular those for the balancing instrument, also include at least one of the following items of information, in particular a plurality of the following items of information, in particular all of the following items of information:
balancing tolerance from database,
further parameters such as total length and total weight from database,
measurement method (e.g. simple/changeover or (automatic) changeover balancing/simple with spindle correction),
balancing method (e.g. unbalance compensation by material removal or material addition or by adjustment of masses) and in particular corresponding balancing planes (height, diameter, . . . ), where mass needs to be added or subtracted.

Furthermore, one preferred configuration also provides that the work instructions, in particular those for the balancing instrument, also include at least one of the following items of information, in particular a plurality of the following items of information, in particular all of the following items of information:
clamp complete tool into balancing spindle,
measurement run according to predefined measurement method (e.g. simple/changeover/simple with spindle correction),
unbalance compensation according to predefined method,
checking the balancing accuracy (test run), reading actual unbalance into database,
transmit result to processing management system (or the database thereof),
optionally repeat process until result OK (the course of balancing is thus traceable in the processing management system).

It is also expedient if the processing management system
monitors a status, in particular an online status, of at least one instrument, in particular of all instruments, and/or
documents processes of at least one instrument, in particular of all instruments, in particular also documents interventions, in particular manual interventions, in processes,
and/or monitors compliance with predefined or predefinable tolerances during the processes of at least one instrument, in particular of all instruments, and/or
monitors and/or documents changes, in particular of an instrument status, of work instructions/data, values, tolerances and/or other items of information and/or
counts and/or documents process repetitions, in particular with reference to the unique identification of the tool holder and/or of the tool, and/or
updates work instructions/data and/or
generates work instructions/data in the case of undesired states, in particular fault states and/or faulty or faultily implemented processes, and/or
generates a job list from the work instructions and in particular makes available or communicates the job list to the instruments of the processing environment (this can be transmitted (as “job”) to a machine in advance by the processing management system or be requested from the processing management system by the machine at the time of implementation) and/or
counts and documents processing processes, in particular those which are implemented on the instruments of the processing environment, in particular when creating the complete tool, and/or
communicates bidirectionally in or with the processing environment or with the instruments of the processing environment and/or
“tracks” (live) a status of instruments integrated into the environments (status: online/offline; status: job feedback (good/bad)),
checks the last implemented job(s) from a one-to-one identification (last result of the implemented job is displayed on the one-to-one identification—it can thus be ensured that all necessary steps have also been implemented.),
without any gaps records the history of the implemented work on the machines and documents the implemented work on the machines.

Corresponding devices therefor can be provided on the processing management system. For example, there may be provide visualization apparatuses by means of which these aspects can be visualized.

Furthermore, it proves to be expedient if the work instructions/data are communicated, in particular bidirectionally, via an OPC-UA interface, and/or a client interface or an MQTT interface.

Moreover, it can be provided that the method and/or the processing management are/is computer-implemented, for example on a control unit/a control computer—or alternatively on distributed systems/computers.

In this regard, it is for example also possible for the processing management system to function centrally—or in particular on the instruments of the processing environment. In the decentralized case, data can then be synchronized between the “decentralized” processing management systems—and these can thus be iteratively complemented.

The processing management system can furthermore advantageously carry out evaluations regarding data, for example regarding a number of processing steps, e.g. a number of mounting/shrink fitting cycles (per individual identification of a complete tool/tool/tool holder). In particular unique user data such as time stamps and user identifier are suitable here.

In this regard, it is then possible in particular also to conduct evaluations of the complete tool presetting space, including job data with target/actual values. On the basis thereof—in the case of tolerance deviations, for example, a traffic light function (RED/GREEN) can then indicate this. To put it more generally, evaluations can lead to indications, notifications, warnings and the like, and also trigger processes in this regard.

If for example the data are provided with the aforementioned time stamps and/or user identifiers/data, then the evaluation can for example yield when (in the (night) shift) “something went wrong”- and in particular the processing management system can make a corrective intervention. Alarm functions and/or notifications to a “supervisor” are also conceivable.

A preferred warning message, in the context of a shrink fitting instrument, can be an overheating warning (shrink fitting alarm) together with writing back the overheating in the case of a unique identifier or one-to-one identification (cf. “Unique ID”) of the tool holder or shrink fit chuck.

In other words, the instrument, but in particular the processing management system, documents the overheating warning—and—in the case of overheating—it documents this “event” for the respective identifier/identification, such that a warning is given that the identified shrink fit chuck was overheated.

Furthermore, it proves to be expedient if the processing management system provides means for operator control, for display, for visualization, reading in and/or for printing out. For example, data of the processing environment, in particular from the instruments or data therein regarding processings/processing steps/processing processes, for example an allowance, a projecting length of a tool, can thus be visualized in a display.

If the processing management system is also a central monitoring and/or control instrument for the processing environment, it also proves to be expedient in particular if the processing management system ascertains, validates and logs and/or monitors and/or controls states/shortcomings and/or processing steps/processes in the processing environment or at the instruments of the processing environment, validates, incorporates and/or links instruments of the processing environment, communicates confirmations (of states or shortcomings) into the processing environment or to the instruments of the processing environment or makes them available there or receives them having been communicated from there and compares data with the instruments of the processing environment.

Finally, with regard to the invention it can be stated that the invention with all its aspects is distinguished in particular by simplicity, efficiency and effectiveness.

The description of advantageous configurations of the invention given hitherto contains numerous features which in part are reproduced in combination as a plurality in the individual dependent claims. However, these features can expediently also be considered individually and combined to form expedient further combinations.

Even if in the description or in the patent claims some terms are each used in the singular or in conjunction with a numeral, the scope of the invention for these terms is not intended to be limited to the singular or the respective numeral. Furthermore, it will be understood that the terms “a,” “an,” and in some cases “one” in this specification should not be understood as numerals, but rather as indefinite articles.

The above-described properties, features and advantages of the invention and the way in which they are achieved will become clearer and more clearly understood in association with the following description of the exemplary embodiments of the invention which are explained in greater detail in association with the drawings/figures (identical component parts/components and functions have identical reference signs in the drawings/figures).

It will be understood that exemplary embodiments serve for explaining the invention and do not restrict the invention to combinations of features specified therein, not even in regard to functional features. Moreover, features suitable therefor in each exemplary embodiment can also explicitly be considered in isolation, removed from an exemplary embodiment, introduced into a different exemplary embodiment in order to supplement same and be combined with any of the claims.

Although the invention is illustrated and described herein as embodied in a processing management during processing of a complete tool comprising a tool holder and a tool, it is nevertheless not intended to be limited to the details shown, since various modifications and structural changes may be made therein without departing from the spirit of the invention and within the scope and range of equivalents of the claims.

The construction and method of operation of the invention related to the first object of the invention, however, together with additional objects and advantages thereof will be best understood from the following description of specific embodiments when read in connection with the accompanying FIG. 1 of the drawing. Similarly, the construction and method of operation of the invention related to the second object of the invention, however, together with additional objects and advantages thereof will be best understood from the description of specific embodiments when read in connection with the accompanying FIGS. 2-6 of the drawing that follow further below.

### BRIEF DESCRIPTION OF THE FIGURES

FIG. 1 shows processing management during processing of a complete tool comprising a tool holder and a tool in a manufacturing environment of component manufacture in accordance with an embodiment according to the invention.

FIG. 2 shows a presetting instrument by means of which an autonomous measurement of a tool is implementable, in accordance with one embodiment according to the invention,

FIG. 3 shows a control menu in the case of the presetting instrument according to FIG. 2, which illustrates an autonomous measurement of a tool, in accordance with one embodiment according to the invention,

FIG. 4 shows an excerpt from the control menu according to FIG. 3 in the case of the presetting instrument according to FIG. 2, which illustrates an autonomous measurement of a tool, in accordance with one embodiment according to the invention,

FIG. 5 shows a cumulative image (with a cumulative geometry and a minimum contour) of a milling tool which is generated during an autonomous measurement of a tool, in accordance with one embodiment according to the invention,

FIG. 6 shows a measuring device carrier in the case of a presetting instrument with integrated reader, in accordance with one embodiment according to the invention.

### DETAILED DESCRIPTION OF THE INVENTION

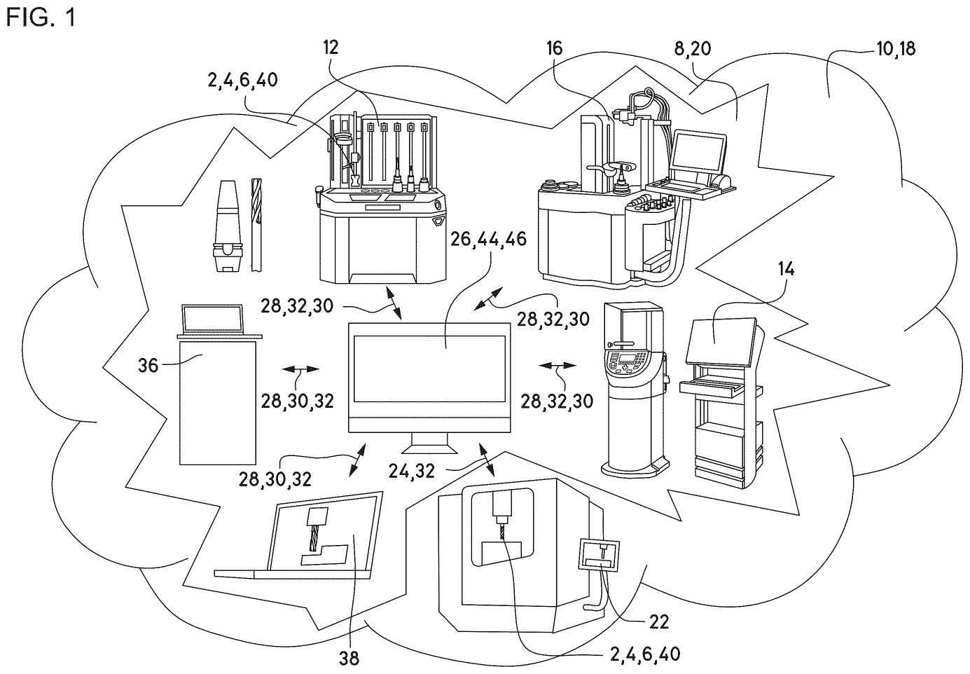

Referring now to the figures of the drawing in detail and first, in particular, to FIG. 1 thereof, there is illustrated the processing management during processing of a complete tool comprising a tool holder and a tool in a manufacturing environment of component manufacture. The exemplary description therefore pertains to the above-mentioned “first” object of the invention.

FIG. 1 schematically shows an integrated or networked manufacturing environment 10 in which components are (can be) manufactured in substantially fully automated fashion ((component) manufacturing process 18).

The illustration shows the component manufacture 18 (in the manufacturing environment 10) by means of a machine tool 22, namely—illustrated in FIG. 1—a CNC milling machine 42, which then means that components are milled as manufacturing process 18.

During the component manufacture 18 or during the milling of the components, in the machine tool 42 complete tools 6 are used in which the tool 2, in this case a milling tool 2, miller for short, is held clamped in a tool holder 4, in this case a shrink fit receptacle/chuck 4.

If the component manufacture 18—here by means of the CNC milling machine 42—is effected using precisely such a complete tool 6—and if wear occurs on the tool 2 or miller 2 during the component manufacture 18, then this necessitates mounting of the complete tool 6 or exchange of the miller 2 in the shrink fit chuck 4 (and then a complete tool change on the CNC milling machine 42).

All this can be ensured by the manufacturing environment 10 in substantially fully automated fashion, which is attributable to or can be ensured by an integrated processing environment 8—described below—which is monitored/controlled by means of a processing management system 26.

As is thus also illustrated—schematically—here in FIG. 1, this takes place in the aforementioned subordinate (to the manufacturing environment) integrated and networked processing environment 8, in which instruments (inter alia 12, 14, 16)—required for such a tool change—are networked—and which instruments thus execute the complete tool creating process 20—depicted here.

In the case shown here in FIG. 1—known instruments, namely a shrink fit instrument 12 (with cooling), a balancing instrument 14 and a presetting instrument 16 and also tool management and commissioning 36 and a CAD/CAM system 38, are interconnected or networked/integrated with one another in the processing environment 8.

As is furthermore shown in FIG. 1, the processing environment 8 provides central (processing) management 26, by way of which processes, sequences, communication and the like (of the instruments in the processing environment 8) can be monitored and in particular controlled.

What is used for this here is—illustrated in a stylized way in FIG. 1—a so-called processing management system 26, which shall be designated here for short just as TRM 26.

In short, the TRM 26 monitors and controls the processes, the sequences and the communication (of the instruments) in the processing environment 8—and can thus realize processes applicable throughout the processing environment 8—and moreover in the manufacturing environment 10, thereby enabling full automation (of the processes) in the environments 8, 10.

For this purpose, the TRM 26 provides that using processing data 24 communicated in particular by a superordinate manufacturing planning/control 22 for manufacturing 18 a component—put simply from the manufacturing environment 10 —, work instructions/data 28, 30 are ascertainable or ascertained by the TRM 26.

Furthermore, the TRM 26 then provides that these work instructions/data 28, 30 are communicable or are communicated (OPC-UA interfaces 32) to the instruments of the integrated/linked or networked processing environment 8.

By means of these work instructions 28 and work data 30, the processes are then implemented on the instruments or are implementable in this way. In short—the TRM 26 can thereby monitor and control the instruments of the processing environment 8 (and control the complete tool creating process 20).

Such processing data 24 (of the manufacturing environment 10) mentioned above could be in this case for example (digital) tool lists 24 and (digital) device sheets 24—known and customary per se. The work instructions 28 and work data 30 of the TRM 26—and also the functionality thereof—shall then be described in greater detail hereinafter.

Put simply and clearly, the TRM 26 becomes the central entity which monitors and/or controls the processing environment 8 or the instruments of the processing environment 8.

If the data and information exchange within the processing environment 8 is effected via known OPC-UA bidirectional interfaces 32, then the instruments of the processing environment 8 can also transmit data and items of information, e.g. requests and the like, back to the TRM 26.

Put simply and clearly—the instruments of the processing environment 8 can give feedback, for example about their states and/or shortcomings, during processes to the TRM 26.

The incorporation of the TRM 26 (then further) “upward” into the manufacturing environment 10 thus enables component manufacture 18 to be fully automated throughout as discussed.

An essential part of the TRM 26 is a central database 44, which includes tool data, tool holder data, (processing) data, such as in particular shrink fitting and balancing and/or presetting parameters.

Complete tool management can thus also be made available by way of these data.

From such data, the TRM 26—put simply and clearly—can thus then “assemble” the complete tools 6 (requested by the manufacturing environment 10 and comprising tools 2 and tool holder 4), i.e. the complete tool 6 comprising shrink fit chuck 4 and miller 4—and then also link these with corresponding processing parameters (e.g. shrink fitting/balancing/presetting parameters).

Suchlike can then again be part of work instructions/data 28, 30, whereby the instruments in the processing environment 8 are or become (centrally) controllable. In other words, the aforementioned work instructions 28 and work data 30 generated by the TRM 26 are essential for integrated, central control and monitoring of the processing environment 8.

In this regard, in particular the work data 30 for the shrink fit instrument 12 can include at least one of the following items of information, in particular a plurality of the following items of information, in particular all of the following items of information:
type of the tool holder, in particular of the shrink fit chuck, (optionally also article number) and/or storage location of the tool holder, in particular of the shrink fit chuck,
unique identification, in particular number, of the tool holder, in particular of the shrink fit chuck,
type of the tool, in particular of the miller, and/or storage location of the tool, in particular of the miller,
unique identification, in particular number, of the tool, in particular of the miller, in particular in the case where the already used tool, in particular the miller, still has enough remaining running time, and/or of the tool holder, in particular of the shrink fit chuck,
number of identical tools required, in particular depending on a planned unit quantity of a component to be manufactured and a service life of the tool, in particular of the miller, in particular also taking account of a remaining running time in the case of used tools, in particular millers,
target length of the complete tool with tolerances,
allowance (optionally also to be adapted),
number of mounting cycles, in particular shrink fit cycles, of the tool holder, in particular of the shrink fit chuck.

The work instructions 28 for the shrink fit instrument 12 can include at least one of the following items of information, in particular a plurality of the following items of information, in particular all of the following items of information:
remove tool holder, in particular shrink fit chuck, and/or tool, in particular miller, in a predefined unit quantity from storage,
reading, in particular scanning, a unique identification, in particular data matrix code and/or number, on/of the tool holder, in particular shrink fit chuck, and/or on/of the tool, in particular the miller,
in particular automatic selection of shrink fit parameters, in particular with an allowance,
display of or of all relevant shrink fit parameters/data,
drive length stop to a predefined or predefinable length, possibly automatically or manually with user guidance on the mounting instrument, in particular on the shrink fit instrument,
display of coarse setting, in particular with color display, in particular red/green,
upon approaching the target dimension, fine display, in particular with color display, in particular with red/green,
heat tool holder, in particular shrink fit chuck,
insert tool, in particular miller,
pivot in length stop,
raise tool, in particular miller, to length stop (manually or with compression spring),
waiting time until tool, in particular miller, is clamped,
cool tool holder, in particular shrink fit chuck,
monitoring of the cooling process,
control actual length with length stop,
storing the actual length in database,
identifying the complete tool with the unique number of the tool holder, in particular of the shrink fit chuck,
in particular as an alternative to shrink fitting for mechanical clamping chucks, an automatic display of tool holder parameters, in particular torque to be used for the in particular collet chuck or hydro-expansion chuck for technically proper mounting and also the associated accessories for turning plate holders such as sliding blocks, mounting apparatuses and the like, and also final representation of the complete tool for confirming the technically proper mounting, in particular together with the length tolerances thereof.

The work data 30 for the presetting instrument 16 can include at least one of the following items of information, in particular a plurality of the following items of information, in particular all of the following items of information:
a piece of geometry information, in particular a total length of the complete tool and/or a diameter of the tool, in particular of the miller, and/or corner radius of the tool, in particular of the miller
a tool service life, in particular in the form of components per new tool or service life in minutes/hours.

The work instructions 28 for the presetting instrument 16 can also include at least one of the following items of information, in particular a plurality of the following items of information, in particular all of the following items of information:
insert complete tool in measurement spindle,
optionally starting of an automatic measurement run—or starting of a manual measurement, in particular of predefined variables,
reading actual dimensions into database and/or transmitting actual dimensions to processing management system (or the database thereof),
additionally—transmitting presetting data to processing machines as well.

The work data 30 for the balancing instrument 14 can include at least one of the following items of information, in particular a plurality of the following items of information, in particular all of the following items of information:
balancing tolerance from database,
further parameters such as total length and total weight from database
measurement method (e.g. simple/changeover or (automatic) changeover balancing/simple with spindle correction),
balancing method (e.g. unbalance compensation by material removal or material addition or by adjustment of masses) and in particular corresponding balancing planes (height, diameter, . . . ), where mass needs to be added or subtracted.

The work instructions 28 for the balancing instrument 14 can include at least one of the following items of information, in particular a plurality of the following items of information, in particular all of the following items of information:
clamp complete tool into balancing spindle,
measurement run according to predefined measurement method (e.g. simple/changeover/simple with spindle correction),
unbalance compensation according to predefined method,
checking the balancing accuracy (test run), reading actual unbalance into database,
transmit result to processing management system (or the database thereof),
optionally repeat process until result OK (the course of balancing is thus traceable in the processing management system).

Besides the aforementioned work instructions 28 and work data 30, the functionalities of the TRM 26 also play an essential role.

In this regard, in the case of the TRM 26 it is provided that the latter
monitors a status, in particular an online status, of at least one instrument, in particular of all instruments, and/or
documents processes of at least one instrument, in particular of all instruments, in particular also documents interventions, in particular manual interventions, in processes,
and/or monitors compliance with predefined or predefinable tolerances during the processes of at least one instrument, in particular of all instruments, and/or
monitors and/or documents changes, in particular of an instrument status, of work instructions/data, values, tolerances and/or other items of information and/or
counts and/or documents process repetitions, in particular with reference to the unique identification of the tool holder and/or of the tool, and/or
updates work instructions/data and/or
generates work instructions/data in the case of undesired states, in particular fault states and/or faulty or faultily implemented processes, and/or
generates a job list from the work instructions and in particular makes available or communicates the job list to the instruments of the processing environment (this can be transmitted (as “job”) to a machine in advance by the processing management system or be requested from the processing management system by the machine at the time of implementation) and/or
counts and documents processing processes, in particular those which are implemented on the instruments of the processing environment, in particular when creating the complete tool, and/or
communicates bidirectionally in or with the processing environment or with the instruments of the processing environment and/or
“tracks” (live) a status of instruments integrated into the environments (status: online/offline; status: job feedback (good/bad)),
checks the last implemented job(s) from a one-to-one identification (last result of the implemented job is displayed on the one-to-one identification
it can thus be ensured that all necessary steps have also been implemented.),
without any gaps records the history of the implemented work on the machines and documents the implemented work on the machines.

Furthermore, it proves to be expedient if, as mentioned, the work instructions/data 28, 30 are communicable or communicated—bidirectionally—via the OPC-UA interface (or alternatively a client interface or an MQTT interface). Instrument feedback (from the instruments to the TRM 26), such as a status, other states or shortcomings at instruments, number of process passes/processing steps and the like, is thus possible.

Furthermore, the TRM 26 also provides an evaluation unit 46, by means of which evaluations regarding data and items of information, such as for example the number (fed back) of processing steps, e.g. a number of mounting/shrink fitting cycles in the case of a specific complete tool 6/tool 2/tool holder 4, can be conducted and (corresponding) logs can be created.

### “UniqueID” 40

What is furthermore primarily important to the processing management system 26 presented here is the allocation of a one-to-one identification (“UniqueID”) 40 to a complete tool 6—comprising assembled specific tool holder 4 and specific tool 2—here in the form of a one-to-one data matrix code (GS1 data matrix) applied by laser treatment on the complete tool 6 or tool holder 4 thereof.

This UniqueID 40 of a complete tool 6 can thus be assigned specific data and items of information of the complete tool 6, such as for example dimensions, tolerances, characteristic values, process parameters (shrink fitting/presetting parameters) and the like, such as also for example the number of mounting cycles (shrink fitting cycles).

By way of this number, then the specific complete tool—across all environments—processing environment 8 and manufacturing environment 10—can thus be “tracked”, monitored and—in processes—controlled.

Only this then makes it possible for processes in the (manufacturing/processing) environment 8, 10 (down to the lowest levels, e.g. mounting, balancing or presetting) also to become completely monitorable and controllable anywhere and at any time—and thus for full automation to become possible—in the processing environment 8 as well as in the manufacturing environment 10.

To put it another way, the allocation of the one-to-one identification 40 or the “UniqueID” 40 for/to a specific complete tool 6 (in the processing environment 8) may be essential for (individual) monitoring, tracking, logging of the complete tool 6 in/during processes in the processing environment 8 (as well as then in the manufacturing environment 10). This in turn is essential for full automation (during the complete tool creating process 20 as well as during the (component) manufacturing process 18).

### Method and Apparatus for Autonomously Measuring a Tool or a Complete Tool

The invention according to the second object of the invention relates to a method and an apparatus for autonomously measuring a tool or a complete tool comprising a tool holder and a tool clamped in the tool holder.

It is conventional to measure a complete tool comprising a tool holder and a tool clamped, for example shrink-fitted, in the tool holder, for example a shrink-fitted milling or clamped cutting tool, before coupling to a machine tool, for example configured as a CNC processing machine, by means of an apparatus for measuring a tool, also referred to for short just as “presetting instrument” (“presetting”).

The (geometric) dimensions of the tool or complete tool which are ascertained in this way by the presetting instrument are then made available to the machine tool, or used therein, for optimization of the workpiece processing in the machine tool.

In particular, the presetting ensures that workpiece-processing parts of the tool, such as for example a cutting edge of a cutting/milling tool, have the position dimensions acceptable for the planned processing of the workpiece on the machine tool. Put simply and generally, tools are checked and inspected for dimensional accuracy of all relevant dimensions and features.

By means of such a presetting instrument, in this case in particular the length of the complete tool, the diameter and/or the cutting edge shape of the clamped tool or cutting/milling tool—and optionally various further proportions of or for the tool or complete tool—are measured.

If these data are directly relevant for the quality of the workpiece processing of the workpiece in the machine tool, the tool measuring in the presetting instrument must take place with high (repetition) accuracy.

Such a measuring device or such a presetting instrument is known for example from the presetting instrument of the type range “UNO” or the type range “VIO” from the applicant Haimer (Haimer Maschinenbau KG, Germany).

This known measurement of complete tools, for example by means of the known presetting instruments, generally takes place in an automated or automatic manner in order to make available a process that is as fault-free and safe and also efficient and effective as possible—for example in the context of automatic industrial manufacturing processes.

However, automatic means at this juncture that although essential partial sequences/processes during tool measurement (can) proceed without action of an operator, such as for example specific measurement processes, a totally operator-independent process, i.e. an autonomous process, has not yet been realized. In other words, even in the case of this automatic process or in the case of this automatic tool measurement according to the prior art, operator actions such as, for example, inputs of tool data and/or identification information for the tool or complete tool through to the complete programming of a measurement sequence into a measurement control are required.

This is also attributable inter alia to the fact that in the case of known tool measurements, partial process steps thereof are extremely complex and possibly inadequate in respect of their structuring, which necessitates the aforementioned operator actions/inputs—and hence the process as a whole proves not to be “autonomizable.” In other words, a completely autonomous process cannot be made available in the prior art.

It is an object of this invention to improve the measurement of tools or complete tools that is known in the prior art in particular to the effect that this measurement becomes or is implementable in a manner completely independent of an operator or free of an operator, i.e. autonomously.

This object is achieved by a method and an apparatus for autonomously measuring a tool or a complete tool comprising a tool holder and a tool clamped in the tool holder—having the features of the respective independent claim.

Advantageous developments of this invention are the subject matter of dependent claims and of the following description and relate both to the apparatus according to the invention and to the method according to the invention.

Any terms that are used, such as top, bottom, front, rear, left or right—unless explicitly defined otherwise—should be understood in the usual way—including with regard to the present figures. Terms such as radial and axial, where used and not explicitly defined otherwise, should be understood in relation to center/longitudinal axes, or axes of symmetry, of component parts/components described here—including with regard to the present figures.

The expression “substantially”—where used—may (in accordance with the understanding of the Supreme Court) be understood to mean “to a practically still significant degree”. Possible deviations from exactness that are thus implied by this concept may thus arise unintentionally (that is to say without any functional basis) owing to manufacturing or assembly tolerances or the like.

“Autonomous” means—to distinguish it from “automated”—that—apart from the initiation of a start signal—no operator intervention or no operator action is necessary or such an “autonomous process” can proceed—using corresponding apparatuses—totally independently (and without an operator).

Hereinafter—for the sake of simplicity—use of the term “tool” is concomitantly also taken to mean the “complete tool” comprising a tool holder and a tool clamped in the tool holder.

In the case of the method for autonomously measuring a (for short) tool, firstly a type of the tool is determined autonomously.

As the type of the tool, it is possible to determine in particular a rotary tool and/or a machining tool, for example a milling tool optionally with turning plates, a drilling tool, a turning tool optionally with cutting plates or a grinding disk.

In particular, it is also expedient in this case if the type of the tool is determined using AI-based image processing.

Then a point on the tool that distinguishes the tool is determined autonomously—depending on the type of the tool.

It is expedient if the point—for example in the case of a drilling tool—is a topmost (or highest) point of the tool or the point—for example in the case of a milling tool or a grinding disk—is a point on an outer edge of the tool.

Proceeding from this point, functional geometries of the tool are measured autonomously.

Such a functional geometry can be for example a cutting edge of a machining tool, such as a milling tool or else drilling tool, or a grinding disk edge region in the case of a grinding disk.

It is expedient in particular if the tool during the measurement, in particular clamped in a spindle, is turned or rotated about its longitudinal axis or central axis, in which case the functional geometry (e.g. a cutting edge) is recognized and the latter is measured autonomously during turning or rotation.

This process of turning/rotation, recognition and measurement can be implemented repeatedly at least until the tool has completed a complete revolution about its longitudinal axis or central axis. Then all functional geometries/cutting edges on the tool have been recognized (maximum number) and all functional geometries/cutting edges have been measured.

Artificial Intelligence AI-based image processing can also be used for this recognition of the functional geometry or the functional geometries.

It is furthermore also advantageous if the measured functional geometry/geometries of the tool is/are saved and/or stored as reference, in which case in particular during a remeasurement of the tool, the newly measured functional geometry/geometries is or are compared with the reference (for example by image comparison).

Here, too, AI-based image processing can be used.

This comparison—of new functional geometry and reference—makes it possible to recognize or ascertain in particular wear on a functional geometry and/or a defective functional geometry.

Subsequently, a cumulative geometry in the case of the tool is ascertained autonomously from the measured functional geometries.

It is expedient here in particular if the cumulative geometry—for example represented by way of a cumulative image—is ascertained from a superimposition of the measured functional geometries of a tool, wherein the cumulative geometry is in particular a course of a maximum outer contour (in particular radial and also axial) in the case of the tool or complete tool.

Furthermore, it can then be advantageous if—using the cumulative geometry of the tool—in particular together with a minimum contour of the tool, a concentricity and/or a planarity and/or a roundness are/is ascertained in the case of the tool.

Such a minimum contour can be taken to mean for example—in comparison with the contour of the cumulative geometry—radially further inward (i.e. closer to the central or longitudinal axis of the tool), (measured) contours or functional geometries, such as in particular radially further inward cutting edges or grinding disk edge regions.

Moreover, it is expedient to store the cumulative image and/or the cumulative geometry and/or the minimum contour of a tool as reference, wherein here, too, then in particular during a remeasurement of the tool the then correspondingly newly determined cumulative images and/or cumulative geometries and/or minimum contours can be compared with their respective reference (for example by image comparison).

Here, too, AI-based image processing can be used.

This comparison then also makes it possible in particular to recognize or ascertain wear on the tool.

Furthermore, it is particularly advantageous if the tool is scanned, wherein in particular a 2D scan and/or a 3D scan are/is implemented—and a corresponding digital image representation of the tool is generated.

In this regard, it is thereby possible to ascertain a digital twin, as described in our commonly assigned, published German patent application DE 10 2017 117 840 A1, the content of which is also hereby incorporated by reference in its entirety, and/or a collision-relevant or machining-relevant digital twin of the tool, as described in our copending application Ser. No. 18/464,402, filed Sep. 11, 2023 (German published patent application DE 10 2022 123 017 A1), the content of which is also hereby incorporated by reference in the subject matter of the application.

It is then also expedient if the measurement/measurements of the tool as well as the functional geometry/geometries thereof and the (collision-relevant/machining-relevant) digital twin are compared.

This comparison can be implemented in particular in relation to or at a tool or complete tool height present or in relation to or at different tool or complete tool heights optionally present (2^{nd}/3^{rd} plane etc.).

For this purpose, it is also expedient for the method not just to be implemented at/in a (first) axial height/plane on the tool. In other words, the method can expediently also be implemented at other axial heights (z-axis) (e.g. second/third plane etc.) on the tool, for example where the diameter of a tool changes (e.g. steps in the case of a “step drill”) and/or where other or additional functional geometries, for example (further) turning/cutting plates, are arranged on a tool, and/or at another (any other) (axial) height possibly present.

Here a/the measuring unit can then be moved autonomously in the z-axis direction/vertically—for example along an outer edge of the tool—as far as a (further) plane, where further functional geometries are recognized—by it—and where the measurement procedure described is repeated.

Furthermore, it can be expedient if measured surface points of the tool—in particular using AI-based image processing—are connected to form a contour of the tool or complete tool.

According to one preferred embodiment, it is provided that the method is implemented with or at/on a rotary tool and/or a machining tool, such as a milling tool, a drilling tool or a grinding disk.

Furthermore—in accordance with one particularly preferred development—the method can comprise one or more of the following steps, preferably in the stated order:

In this regard, it is possible to determine a highest point of the tool (cf. the point that distinguishes the tool) on a central axis (longitudinal axis) of the tool (z-axis). In other words, the central axis (longitudinal axis) of the tool (z-axis) is traversed; the topmost or highest point of the tool is then determined on this axis.

It is possible (then), in particular using the highest point, to check whether a tip is present on the tool. For example, means of artificial intelligence or image processing on the basis of AI can also be used for this purpose.

Moreover, this can be performed for example in such a way that neighboring points of the tool with respect to the highest point are sought/measured. If these points lie—axially (in the central axis/longitudinal axis or z-axis direction)—below the highest point, then a tip can be assumed (at the highest point).

In the case of a tip—a drilling tool can (then) be determined as the type of the tool.

In the case of no tip—a radially outer edge on the tool (cf. the point that distinguishes the tool) can (then) be determined and cutting edges (cf. functional geometry) on the tool can (then) be determined, in particular using the radially outer edge. This can be done in particular using predefined comparison patterns (optionally using AI).

The cutting edges can then be measured.

If cutting edges are found (and optionally measured), then the tool can furthermore also be assumed to be a milling tool. If such cutting edges are also absent, a grinding disk could also be assumed, in the case of the tool, and its circumferential grinding disk edge (cf. functional geometry) can be measured.

It is also particularly advantageous in particular if the method is implemented or if the tool is processed in accordance with the method using the apparatus for autonomously measuring a tool or a complete tool.

The apparatus for autonomously measuring a tool or a complete tool comprising a tool holder and a tool clamped in the tool holder provides a measuring unit and a computing and control unit.

The measuring unit and/or the computing and control unit are/is configured in such a way that firstly a type of the tool is determinable autonomously, then a point that distinguishes the tool is determinable on the tool autonomously depending on the type of the tool, functional geometries of the tool are measurable autonomously proceeding from this point and subsequently a cumulative geometry in the case of the tool is ascertainable autonomously from the measured functional geometries.

It is expedient in particular if the measuring unit and/or the computing and control unit are/is configured for implementing the method or method steps according to the invention.

In this case, a “ . . . unit”, such as the measuring unit and the computing and control unit, can in particular also comprise a processor, a storage unit, an interface and/or an operating, control and calculation program, in particular stored in the storage unit.

Optionally, the measuring unit and/or the apparatus can comprise a control unit that provides for corresponding control of the measuring unit for implementing one of the above-described methods according to the invention or method steps according to the invention.

According to one configuration, it can be provided that the measuring unit comprises one or more optical and/or non-contact-measurement measuring apparatuses, for example a digital camera and/or a radar and/or a lidar and/or a measuring apparatus that operates according to a transmitted or reflected light method, in particular with a (digital) image sensor. Different kinds of measuring apparatuses, too, can alternatively be provided, such as for example a laser curtain—or else other tactile or optical measuring systems.

Furthermore, it can be expedient here if—in the case of a plurality of measuring apparatuses—the tool or the complete tool or the functional geometry thereof is measured from different perspectives (axes), in particular in the case of turning tools, whereby in particular positions of functional geometries, such as cutting edges or cutting plates, for example, can be determined.

Moreover, it is advantageous if the type of the measuring apparatus is chosen depending on a requirement in respect of a measurement accuracy.

A processing center provides the apparatus and also a machine tool.

It is expedient here in particular if the apparatus and the machine tool are mounted on a common base and/or if the apparatus is integrated into the machine tool (functionally and/or from a component standpoint) into the machine tool.

This invention is based on the insight that autonomous measurement of a tool becomes or is realizable only if, firstly, each process/method step by itself is automatable and all process/method steps are implementable jointly in an integrated work environment, for example in a single apparatus, such as a presetting instrument, and, secondly, each piece of information necessary for the respective process/method step is in each case already present at the beginning of each process/method step.

Proceeding therefrom, this invention generates a specific, surprisingly simple method regime according to the invention, or inventive method regime, with a specifically sorted sequence of automatable or automated process/method steps, which method regime fulfils or ensures prerequisites above.

Thus, in the case of the method regime according to the invention, or inventive method regime, operator actions can be dispensed with, the latter are not necessary here—and the autonomous method for measuring a tool that results from the method regime according to the invention, or inventive method regime, becomes—as a whole—totally autonomously implementable.

As a result, this invention can then make available a fault-free and safe and also highly efficient and highly effective process—for example in the context of automatic industrial manufacturing processes. This invention thus makes a valuable contribution to the intelligent networking of machines and sequences in industry/industrial manufacturing, i.e. to Industry 4.0.

A further aspect of this invention related to the second object pertains to an apparatus for autonomously measuring a tool or a complete tool, in particular the apparatus, which provides a reader for reading data of a data carrier arranged on a tool holder at a measuring device carrier of the apparatus.

The description of advantageous configurations of this invention given hitherto contains numerous features which in part are reproduced in combination as a plurality in the individual dependent claims. However, these features can expediently also be considered individually and combined to form expedient further combinations—including between the arrangements/apparatuses and methods.

It will be understood that the exemplary embodiments serve for explaining this invention and do not restrict this invention to combinations of features specified therein, not even in regard to functional features. Moreover, features suitable therefor in each exemplary embodiment can also explicitly be considered in isolation, removed from an exemplary embodiment, introduced into a different exemplary embodiment in order to supplement same and/or be combined with any of the claims.

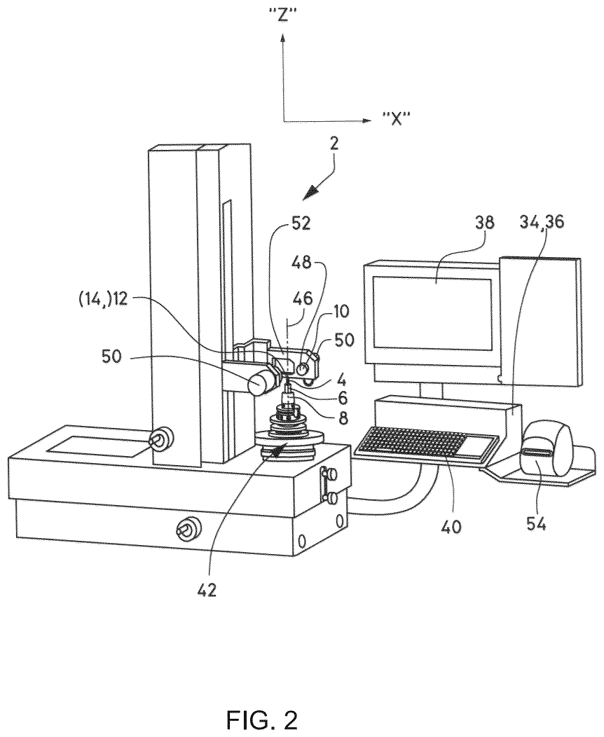

Referring once more to the figures of the drawing in detail and now, in particular, to FIGS. 2-6 thereof, there is illustrated a process for the autonomous measurement of a tool.

FIG. 2 shows in detail a tool presetting instrument 2 or, for short, presetting instrument 2—for measuring a tool 4 or complete tool 6 (tool holder 8 and tool 4).

The presetting instrument 2 comprises an optical measuring apparatus 10, in the form of a camera apparatus 10, by means of which items of information from the tool 4 or complete tool 6 are recordable—put briefly and simply, this tool is measurable.

In addition, the presetting instrument 2 comprises a computing and control unit 34 comprising inter alia a processor, a storage unit (memory for short), an interface with the camera apparatus, an interface 36 with a machine tool, and calculation and operating programs that are stored in the storage unit, are executable by the computing and control unit 34 and are “operable” via a display means 38 and input means 40, such as the autonomous measurement of a tool 4 (“Maximum SE”) which is the focus of attention here—and furthermore also the generation of the data for a collision-relevant digital twin and a machining-relevant digital twin of a tool 4 or complete tool 6, as described in our prior German application DE 10 2022 123 017 A1.

The computing and control unit 34 is—by means of corresponding calculation and operating programs—moreover also provided for enabling execution of or implementing a customary measurement of a tool 4 or of a complete tool 6—using the camera apparatus 10 —, customary presetting data being generated by the tool 4 or the complete tool 6.

Furthermore, the computing and control unit 34—likewise by means of corresponding calculation and operating programs and using the camera apparatus 10—makes it possible to generate data of the tool 4 or of the complete tool 6 for a collision check, namely the collision-relevant digital twin and the machining-relevant digital twin.

The or all measurement or presetting data—including those from the autonomous measurement of a tool 4 (“Maximum SE”) (referred to jointly for short just as measurement or presetting data)—and/or data of the collision-relevant digital twin and of the machining-relevant digital twin, for short the collision-relevant and the machining-relevant digital twin, can be provided—in the form of one or more data sets—in digital form for further machine processing, for example in the data formats VDA-FS, IFC, IGES, STEP, STL and DXF.

In the present case, separate data sets of measurement data, presetting data and the digital twins, and also a common data set of the digital twins, are provided.

Via the interface 36 with the machine tool (not shown), the data or the data sets can be transferred/communicated to the machine tool (where inter alia the simulated collision check is implementable or is implemented by means of the data).

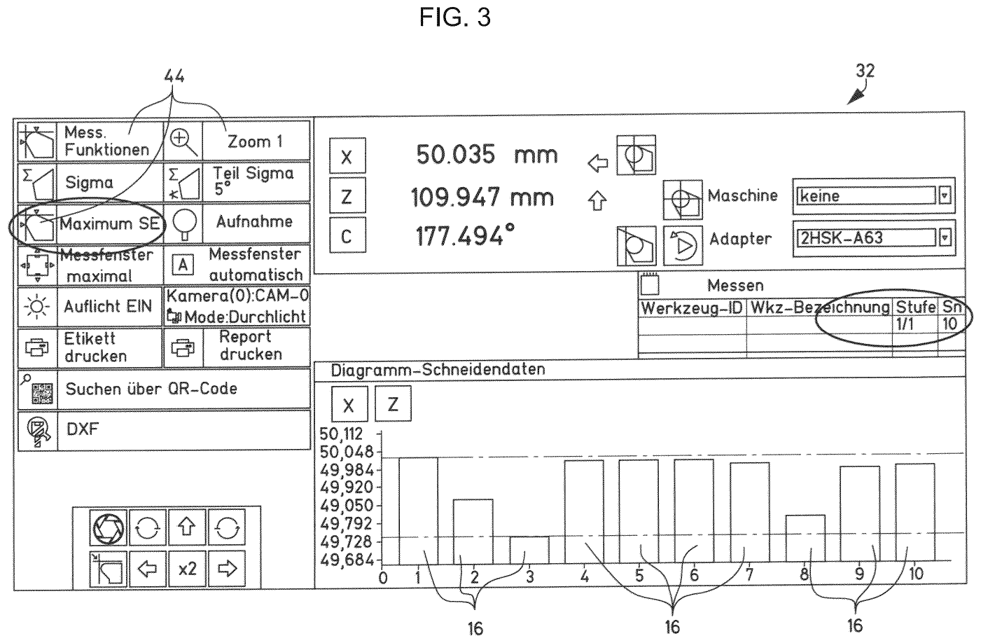

The presetting instrument 2 furthermore comprises, as shown by FIG. 2 (cf. also FIGS. 3 to 5), the display means 38 in the form of a monitor 38 (with the functionality of a touchscreen) and the input means 40, which is configured as a (separate) keyboard 40. Moreover, the input means 40 is also configured as a touchscreen-functional monitor 38.

An operator can operate the calculation and operating programs via the keyboard 40 and the touchscreen 38, with functionalities, data and status displays of the calculation and operating programs being displayed (and thereby also becoming operable) on the monitor 38, —and initiate forwarding of the data or the data sets to the machine tool—via the interface 36.

As also shown by FIG. 2, the complete tool 6 is arranged on a spindle 42 which in a manner controlled by means of a corresponding function program—in particular also automatically by an actuator (not illustrated in more specific detail)—is rotatable about a rotation/central or longitudinal axis 46 (z-axis).

The afore-mentioned camera apparatus 10 of the presetting instrument 2 is configured as a transmitted-light system. In this case, a camera 48 and an illumination means 50 lie on opposite sides of a complete tool 6 arranged on the spindle 42. The camera apparatus 10 is mounted on a slide 52—and is displaceable along two axes (“x” and “z”) manually and in particular also automatically—in a manner controlled by means of a corresponding function program.

An interface for a printer 54 is furthermore available.

### Function Program “Autonomous Tool Measurement” (“Maximum SE”)

FIGS. 3 to 5 illustrate the sequence of the function program for autonomously measuring a tool or complete tool.

FIG. 3 shows the control menu or operating and display interface 32 such as is displayed on the display means 38/monitor/touchscreen 38 of the presetting instrument 2—and via which the autonomous measurement of a tool or complete tool is implemented or started.

The illustration shows, on the left-hand side of the operating interface 32, various function programs of the presetting instrument 2—in the form of an arranged function button 44, and actually also the function program for autonomously measuring a tool or complete tool, designated “Maximum SE” (cf. how this is identified by the border marked around it, FIG. 3).

Touching the function button 44 “Maximum SE” causes the autonomous measurement of a tool or complete tool to be started—which then proceeds thereafter totally without an operator or autonomously. In other words, any arbitrary tool that is not known at this time can be measured (and be created as a new tool in the tool management (as a data set))—without further operator assistance.

The camera apparatus 10 “searches” for the (arbitrary and “unknown”) tool 4 clamped/held in the spindle 42. In other words, the camera apparatus 10 moves autonomously along the central axis 46 of the tool (z-axis) until it detects/recognizes (there) “first parts/regions” of the tool 4. In this case, it moves autonomously at the level of the highest point 12 of the tool 4 clamped/held in the spindle 42.

In this regard, it is thereby possible to determine a highest or topmost point 12 of the tool 4 on the central axis (longitudinal axis) 46 of the tool (z-axis).

The highest point 12 is then used to check whether a tip 14 is present on the tool 4. Means of image processing on the basis of AI are used here for this purpose.

Alternatively, this could also be realized by searching for/measuring neighboring points with respect to the highest point 12 on the tool 4. If these points lie—axially (in the central axis/longitudinal axis or z-axis direction)—below the highest point 12, then a tip 14 can be assumed (at the highest point 12).

In the case of a tip 14—the hitherto “unknown” tool 4 is then determined/classified as a drilling tool. The further measurement of functional geometries 16 of a “drilling tool” (for short also just “drill”) ensues.

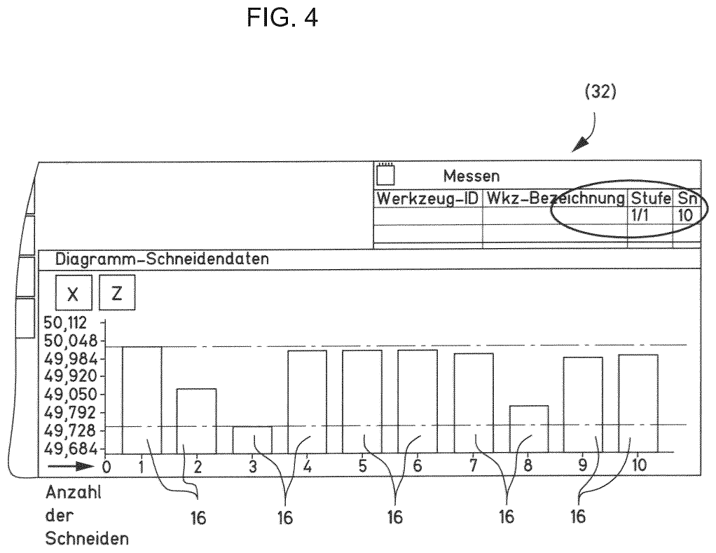

Since however—in the present case—the “unknown” tool 4 is a milling tool (having ten cutting edges) (cf. FIG. 4), no tip 14 will be found at the tool 4—and this tool 4 will therefore also not be categorized/recognized as a drilling tool.

In the case of this “no tip” at the tool 4, a radially outer edge 18 is then determined on the tool. In other words, the camera apparatus 10 moves radially outward (x-axis)—to the radially outer margin 20 of the tool 4.

The camera apparatus 10 detects the radially outer margin 20—and the spindle 42 begins to turn the tool 4 or complete tool 6 clamped in it (about its longitudinal/central or z-axis 46).

While the tool 4 is rotating, the camera apparatus 10 continuously determines the contour 22 of the tool 4 in the respective turning position. The determined contours 22 are evaluated, here using predefined comparison patterns, to the effect of whether a cutting edge 16 (functional geometry 16) of the tool 4 is recognizable in the contour course (of the respective turning position of the tool 4). If a contour 22 is recognized as a cutting edge 16/functional geometry 16, the latter is also measured.

The tool 4 is completely rotated (360°) at least once about its central or longitudinal or z-axis 46, and in this way—at the end of the rotation process—all cutting edges 16 (functional geometries 16) (possibly present in the case of a cutting or milling tool) have been recognized—and then also measured in such a case.

Therefore, it is now definite whether (a) the tool 4 is a milling or cutting tool—and (b) a cutter with how many cutting edges is present here.

In the present case described here, cutting edges 16 (functional geometries 16)—ten in number—were recognized and measured, where the “unknown” tool was thus now identified and correspondingly classified as a milling tool having ten cutting edges.

FIG. 3 and in the detail therefrom FIG. 4 show the measurement of the (in this case ten) cutting edges 16 (functional geometries 16) of the—in this case—milling tool.

As revealed by FIGS. 3 and 4 (excerpt from the operating interface/touchscreen 38), —in this case—the “x”-dimensions, i.e. the radial dimension, of the ten cutting edges 16 are represented graphically (in bar form (height of the bar corresponding to radial dimension)). By “switching” to the “z”-dimension, the respective “z”-dimensions (z-axis) of the ten cutting edges 16 are then also represented accordingly. In one variant, x- and z-dimensions could also be displayed simultaneously in a superimposed form.

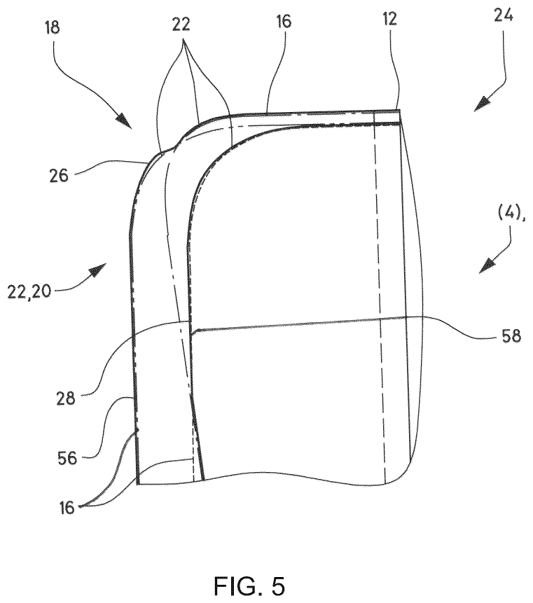

The respective representations make it possible to be able quickly and easily to recognize differences in the cutting edges 16 or the states thereof, e.g. the furthest outer cutting edge 56 (cf. FIG. 5) (FIGS. 3 and 4—cutting edge 1) vs. the furthest inner cutting edge 58 (FIG. 5) (FIGS. 3 and 4—cutting edge 3) (cf. FIG. 3 and respectively FIG. 4—correspondingly marked by the two straight lines) or the highest cutting edge vs. the lowest cutting edge.

In this respect, FIG. 5 shows a corresponding cumulative image 24, in which—using the measured cutting edges 16—the cutting edge contour courses thereof are represented in a jointly superimposed manner.

In the cumulative image 24, as shown in FIG. 5, the measured functional geometries/cutting edges 16 of the tool are represented in a superimposed manner (in “x” and “z”), whereby in this way—in the image (also computationally ascertainable)—a maximum outer contour 26 referred to as cumulative geometry 26—here in “x” and “z”—is manifested in the case of the milling tool/tool 4.

Equally, in this way a minimum contour 28—for example likewise from the cumulative image 24—can be inferred or (also computationally) determined, which minimum contour—put simply and clearly (as a counterpart of the cumulative geometry 26)—forms a “minimum inner contour” 28.

From maximum outer contour 26 or cumulative geometry 26 and minimum inner contour 28 (in “x”), in this way it is then also possible to ascertain a concentricity, a planarity and a roundness in the case of the tool 4.

Once the cutting edges 16 (functional geometries 16) of the tool 4 have been measured, these are stored as reference (in a memory or tool management system)—and during a remeasurement of this tool 4 are thus available as comparison for newly measured cutting edges 16/functional geometries 16 of this tool 4.

Pieces of wear information for the tool 4 can be ascertained from such a comparison. From the pieces of wear information, it is then also possible to derive other properties such as e.g. a remaining service life or a remaining service life travel.

If no individual cutting edge/edges 16 has/have been recognized during the contour recognition (see above), in the case of such a tool 4 (also no tip 14—see above) a grinding disk 4 can be assumed and its circumferential grinding disk edge 18 (cf. functional geometry 16) is then measured. Here, too, cumulative image 24, cumulative geometry 26 and minimum contour 28 can then be ascertained, stored and evaluated (e.g. concentricity, planarity, . . . ).

If a tip 14 was recognized in the case of a tool 4—and the latter was thus classified as a drill 4, then the camera apparatus 10 moves axially to the height at which the tool/the drill 4 or the drilling tip thereof has its maximum external diameter, —and there radially outward—to the radially outer margin 20 of the tool.

From here the same procedure, as described, as in the case of a milling tool 4 takes place—in the case of a drilling tool 4.

The camera apparatus 10 detects the radially outer margin 20—and the spindle 42 begins to turn the tool/drill 4 clamped in it (about its longitudinal/central or z-axis 46).

While the tool/drill 4 is rotating, the camera apparatus 10 continuously determines the contour 22 of the tool/drill 4 in the respective turning position. The determined contours 22 are evaluated to the effect of whether a cutting edge 16 (functional geometry 16) of the tool 4 is recognizable in the contour course (of the respective turning position of the tool 4). If a contour 22 is recognized as a cutting edge 16/functional geometry 16, the latter is also measured.

The tool/drill 4 is completely rotated (360°) about its central or longitudinal or z-axis 46, and in this way—at the end of the rotation process—all cutting edges 16 (functional geometries 16) have been recognized—and then also measured in such a case. Cumulative image 24, cumulative geometry 26 and minimum contour 28 and also pieces of wear information are correspondingly ascertained, stored and evaluated.

In the case of the autonomous measurement of a tool described here, the measurement at the tool takes place in “only” one plane (first plane—cf. FIGS. 3 and 4 “Level 1/1”—identified by border marked around it), namely at the “outer cutting edge” 18 (near the tip 14 of the tool 4).

Such a measurement, as described, can also be implemented at other axial heights (z-axis) (second/third plane and so on) on the tool 4, for example where the diameter of the tool 4 changes (e.g. steps in the case of a “step drill”) and/or where other or additional functional geometries 16, for example (further) turning/cutting plates (functional geometries 16), are arranged on a tool, and/or at another (any other) height.

Here the camera apparatus 10 then moves along the outer edge of the tool 4 until—in a further plane—further functional geometries 16 are recognized and where the measurement procedure described (see above) is repeated. Here, too, cumulative image 24, cumulative geometry 26 and minimum contour 28 and also pieces of wear information can again be correspondingly ascertained, stored and evaluated.

### Function Program “Digital Twin”

The function program “digital twin” is started in accordance with the function program “Maximum SE” described above, in which case here the generation of the (collision-relevant) digital twin is then started (not shown) autonomously or by the touching of the function button “Digital twin” on the display means 38/monitor 38.

### In the Case of Non-Rotating Tool

During the generation of the collision-relevant digital twin of a complete tool 6—here for a non-rotating tool 4, such as for example a turning tool 4, —this tool is scanned—and a digital image representation of the complete tool is thereby created.

The scanning takes place—in this case with a non-rotating tool 4—by means of a 2D scan of the complete tool 6—this scan being implemented by the camera apparatus 10 —, with the measurement of a contour of the complete tool 6 on both sides—in a predefined fixed position of the complete tool 6 (stationary spindle 42).

In this case, in an automated manner, the camera apparatus 10 moves to different heights of the complete tool 6 and at each of these heights makes a recording of the complete tool 6 or of a detail of the complete tool 6, from which recordings the contour or the contour course of the complete tool 6 is then “extracted”, which then forms the (two-dimensional) digital image representation.

This takes place in the form that the camera apparatus 10 is moved step-by-step firstly from the bottom, i.e. from the lower end of the complete tool 6, to the top, i.e. to the upper end of the complete tool 6, the camera apparatus 10 here being oriented toward the contour of one side of the complete tool 6—and the contour of said one side of the complete tool 6 being ascertainable in this case.

Afterward, the camera apparatus 10 moves step-by-step from the top to the bottom, here the camera apparatus 10 being oriented toward the contour of the other side of the complete tool 6—and the contour of the other side of the complete tool 6 being ascertainable in this case.

In addition to the scanning of the complete tool, furthermore, a first cutting edge point, a cutting edge starting point, and a second cutting edge point, a cutting edge end point, are then measured at the tool 4 or the complete tool 6 by means of the camera apparatus 10.

For this purpose it is possible—if there were a desire for this not to be implemented autonomously—for an operator to move the camera apparatus 10 to the two corresponding heights, which the operator can monitor in each case by way of a display on the monitor 38, and the operator focuses the cutting edge starting point and respectively cutting edge end point there—and can then initiate the respective measurement by means of the keyboard 40. Otherwise this takes place autonomously.

In the digital image representation, then using the measured first and the measured second cutting edge points or using these ascertained closest points in the digital image representation a cutting edge region is ascertained (“collision-relevant digital twin”).

### In the Case of a Rotating Tool

During the generation of the collision-relevant digital twin of a complete tool 6—here for a rotating tool 4, such as for example a milling tool 4, —this tool is likewise scanned—and—in this case of a rotating tool 4—a (three-dimensional) digital image representation of the complete tool 6 is created.

The scanning takes place—in this case with a rotating tool 4—by means of a 3D scan of the complete tool 6—this scan being implemented by the camera apparatus 10 —, with the measurement of a contour of the complete tool on one side—with the complete tool 6 being turned in a varying manner (rotating spindle 42).

In this case, in an automated manner, the camera apparatus 10 moves to different heights of the complete tool 6—and at these heights makes in each case recordings of the complete tool 6 or of a detail of the complete tool 6 in complete tool positions turned in a varying manner (by means of the spindle 42), from which recordings the envelope contour of the complete tool 6 is then “extracted”, which then forms the three-dimensional digital image representation.

This takes place in the form that the camera apparatus 10 is moved step-by-step preferably from the bottom, i.e. from the lower end of the complete tool 6, to the top, i.e. to the upper end of the complete tool 6, the camera apparatus 10 here being oriented toward the contour of one side of the complete tool 6. At the heights moved to, in each case different recordings of the complete tool 6 are made—in complete tool positions turned in a varying manner in each case.

In addition to the scanning of the complete tool 6, furthermore, optionally using artificial intelligence, a first cutting edge point, a cutting edge starting point, and a second cutting edge point, a cutting edge end point, are then recognized and measured at the tool 6 or the complete tool 6 by means of the camera apparatus 10.

For this purpose it is possible—if there were a desire for this not to be implemented autonomously—for an operator to move the camera apparatus 10 to the two corresponding heights, which the operator can monitor in each case by way of a display on the monitor 38, and the operator focuses the cutting edge starting point and respectively cutting edge end point there—and can then initiate the respective measurement by means of the keyboard 40. Otherwise this takes place autonomously.

In the digital image representation, then using the measured first and the measured second cutting edge points or using these ascertained closest points in the digital image representation a cutting edge region is ascertained (“collision-relevant digital twin”) and identified as such.

On the basis of these data, the machine tool and/or an external programming station then implement(s) the collision simulation.

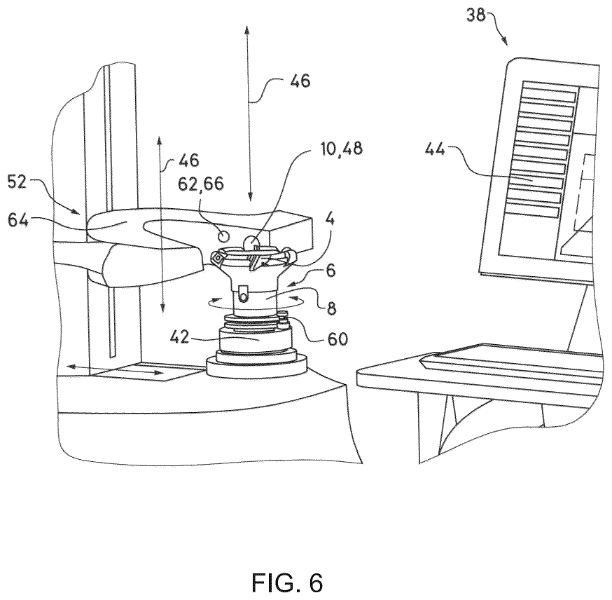

(Measuring Device) Carrier 64 with Reading Device/Reader 62 for Reading from a Data Carrier 60 on the Tool Holder 8 (FIG. 6)

FIG. 6 shows—as part of the slide 52 of the presetting instrument 2—a (approximately U-shaped) measuring device carrier 64 in the case of the presetting instrument 2 with a reader/reading device 62 integrated there for reading from a data carrier 60 on the tool holder 8.

The complete tool 6 held or clamped in the spindle 42—more precisely the tool holder 8—provides a data carrier 60, for example configured here as a contactlessly readable data carrier, such as an RFID chip, by means of which the tool holder 8 can be identified fully automatically (also in the context of prescribed autonomous sequences) and further measurement data therefor can be acquired. The position of the data carrier 60 on the tool holder 8 is standardized in this case (HSK/SK tool holder).

By this means, incorrect assignments or missing tools are avoided and maximum tool deployment and high machine availability are ensured. In this case—by means of the data carrier 60—all tool-relevant data are or have been stored—here contactlessly—on the data carrier, which is fixedly connected to the tool holder 8 (for example as described in DE 10 2016 102 692 A1). In addition or else instead of individual tool data, a code/value uniquely identifying the tool, or the like, can also be stored on the chip.

As also shown in FIG. 6, the complete tool 6 or the tool holder 8 is arranged on the spindle 42, which is rotatable automatically about the rotation/central or longitudinal axis 46 (z-axis)—in particular also by an actuator that is not illustrated in more specific detail.

The above-mentioned camera apparatus 10 of the presetting instrument 2 (cf. FIG. 2, camera 48 and illumination means 50) is arranged on the U-shaped measuring device carrier 64, which is part of the slide 52 of the presetting instrument 2—and which, as indicated in FIG. 6, is movable along two axes (“x” and “z” 46) manually, and in particular also automatically (cf. autonomous process—see above).

Furthermore, a reader 62—having a read/write head 66 that is movable (in the horizontal plane)—is integrated in the measuring device carrier 64, as indicated in FIG. 6, which reader can read out data from the data carrier 60 on the tool holder 8.

Put clearly, the read/write head 66 of the reader 62 moves out of the measuring device carrier 64 directly to the data carrier (in this position, the data can be read out from the data carrier 60)—and also back again into the measuring device carrier.

Data are read out from the data carrier 60 either in a manner integrated autonomously in the process—or as a separate autonomous process by means of a function button 44 on the touchscreen 38 (here touching the function button 44 then starts the autonomous readout process).

The measuring device carrier 64 moves—along the central axis/z-axis 46—autonomously into a basic position, the axial height of which corresponds to the axial height at which the data carrier 60 is secured to the tool holder 8.

The complete tool 6 or the tool holder 8 is rotated—by means of the spindle 42—autonomously about the z-axis—until the data chip 60 arranged in a standardized position on the tool holder 8 ends up in front of the reader 62. In this case, the—adapter-dependent—angle value of the chip position is known in the system, but can optionally be searched for with camera assistance.

A read/write head 66 of the reader 62 moves directly up to the data carrier 60—and reads out the data thereof. Afterward, the read/write head 66 moves back again.

If the positioning of the reading device 62 in front of the data carrier 60 is intended to be effected (totally) without prior knowledge (cf. standardized position), then it can be provided that using A(rtificial) I(ntelligence)-based image processing the camera unit 10 “searches for” the data carrier 60 on the tool holder 8 and thus recognizes or determines the position of said data carrier. Height positioning of the measuring device carrier 64 and spindle rotation and then the readout can then take place accordingly.

Such a reader 62 in the measuring device carrier 64 of a presetting instrument 2 can also be used in a corresponding (also functional) manner for any other machine tool.

Moreover, the read/write head 66 could also simply be a specific camera which is mounted on the measuring device carrier 64 and identifies the tool holder 8—or else a reader 62 which reads a marking, for example a QR code, on the tool holder 8. Such a marking can then identify the tool holder 8 or else include tool data in encoded form.

This additional aspect described here in association with FIG. 6 in the case of a presetting instrument 2 (“(measuring device) carrier 52 with reading device/reader 62 for reading from a data carrier 60 on the tool holder 8 (FIG. 6)”) can also be pursued further as separate subject matter of a divisional application—also independently of the presetting instrument or independently in relation to a presetting instrument.

Although this invention has been more specifically illustrated and described in detail by means of the preferred exemplary embodiments, nevertheless the invention is not restricted by the examples disclosed and other variations can be derived therefrom, without departing from the scope of protection of the invention.

The following is a summary list of reference numerals and the corresponding structure used in the above description of the invention:

### FIG. 1

2 tool
4 tool holder
6 complete tool
8 (integrated/linked) processing environment
10 (integrated/linked) manufacturing environment
12 mounting instrument, shrink fitting instrument
14 balancing instrument
16 presetting instrument
18 (component) manufacturing process
20 complete tool creating process
22 manufacturing planning/control
24 processing data, tool list, device sheet
26 processing management system
28 work instructions
30 work data
32 interface, OPC-UA interface, client/MQTT interface
36 tool management and commissioning
38 CAD/CAM system
40 (one-to-one) identification/code, (one-to-one) data matrix code
42 machine tool/CNC milling machine
44 database
46 evaluation unit

### FIGS. 2-6

2 apparatus for measuring a tool or a complete tool, presetting instrument
4 (rotating/non-rotating) tool, milling tool, grinding disk, drilling tool/drill
6 complete tool
8 tool holder, (hydro-expansion) clamping chuck
10 measuring unit, (optical) measuring device, camera unit
12 (topmost/highest) point
14 tip, drilling tip
16 functional geometry
18 radially outer edge, cutting edge, grinding disk edge
20 radially outer margin
22 contour
24 cumulative image
26 cumulative geometry, maximum outer contour
28 minimum contour, minimum inner contour
32 operating and display interface
34 computing and control unit
36 interface with the machine tool
38 display means, monitor, touchscreen
40 input means, keyboard
42 spindle
44 function button
46 central/longitudinal/rotation axis, z-axis
48 camera
50 illumination means
52 slide
54 printer
56 furthest outer cutting edge 16
58 furthest inner cutting edge 16
60 data carrier, RFID chip
62 reading device/reader (for 60)
64 measuring device carrier (as part of the slide 52)
66 read/write head (of 62)

1. A method for data exchange during control of processing of a complete tool having a tool holder and a tool in an integrated and linked processing environment, the method comprising:
providing at least one instrument for mounting the tool into the tool holder selected from the group consisting of a shrink fit instrument, a balancing instrument, and a presetting instrument, in a manufacturing process for manufacturing a component with the complete tool and with optional further machines and automation components in an integrated manufacturing environment;
communicating, by a superordinate manufacturing planning and control system for manufacturing the component, processing data for processing the complete tool selected from a tool list or device sheets, to a processing management system; and
communicating, by the processing management system, work instructions and data ascertained using the processing data to instruments of the integrated and linked processing environment.

2. The method according to claim 1, which comprises using work instructions and data for monitoring or controlling the instruments of the integrated and linked processing environment under remote control by the processing management system.

3. The method according to claim 1, wherein work data of a mounting instrument include at least one, or a plurality, or all of the following items of information:
type of the tool holder and/or storage location of the tool holder;
unique identification of the tool holder;
type of the tool and/or storage location of the tool;
unique identification of the tool; and
if the tool holder or the tool has already been used before, whether or not the tool holder or the tool still has enough remaining running time;
number of identical tools required depending on a planned unit quantity of a component to be manufactured and a service life of the tool, and also taking into account a remaining running time in the case of previously used tools;
target length of the complete tool with tolerances;
number of mounting cycles of the tool holder.

4. The method according to claim 1, wherein the work instructions for the mounting instrument include at least one, or a plurality, or all of the following items of information:
remove tool holder, in particular shrink fit chuck, and/or tool, in particular miller, in a predefined unit quantity from storage;
read a unique identification, in particular data matrix code and/or number, on/of the tool holder, and/or on/of the tool;
automatically select mounting parameters, with an allowance;
display relevant shrink fit parameters/data;
drive length stop to a predefined or predefinable length, possibly automatically or manually with user guidance on the mounting instrument;
display coarse setting;
upon approaching the target dimension, fine display;
heat the tool holder;
insert the tool;
pivot in length stop;
raise tool to length stop manually or with compression spring;
wait until tool is clamped;
cool tool holder;
monitor cooling process;
control actual length with length stop;
store the actual length in a database;
identify the complete tool with the unique number of the tool holder;
when the tool holder is a mechanical clamping chuck, automatically display tool holder parameters, including a torque to be used for technically proper mounting and also associated accessories for turning plate holders, and final representation of the complete tool for confirming the technically proper mounting and length tolerances thereof.

5. The method according to claim 1, wherein the work data for presetting the instrument include at least one or a plurality or all of the following items of information:
an item of geometry information, including a total length of the complete tool or a diameter of the tool, or a corner radius of the tool; and
a tool service life expressed in a number of components per new tool or a service life in minutes and hours.

6. The method according to claim 1, wherein the work instructions for a presetting instrument include at least one or a plurality of all of the following items of information:
insert complete tool in measurement spindle;
optionally start an automatic measurement run or start a manual measurement of predefined variables,
read actual dimensions into database and/or transmit actual dimensions to processing management system; and
transmit presetting data to processing machines.

7. The method according to claim 1, wherein the work data for the balancing instrument include at least one, or a plurality, or all of the following items of information:
balancing tolerance from database,
further parameters such as total length and total weight from database
measurement method such a simple, changeover or automatic changeover balancing, or simple with spindle correction;
balancing method, including unbalance compensation by material removal or material addition or by adjustment of masses, and corresponding balancing planes where mass needs to be added or subtracted.

8. The method according claim 1, wherein the work instructions for the balancing instrument include at least one, or a plurality, or all of the following items of information:
clamp complete tool into balancing spindle,
measurement run according to predefined measurement method;
unbalance compensation according to predefined method,
checking the balancing accuracy in a test run, reading actual unbalance into database,
transmit result to processing management system;
optionally repeat process until result is okay and a course of balancing is thus traceable in the processing management system.

9. The method according to claim 1, wherein the processing management system:
monitors a status, in particular an online status, of at least one instrument or of all instruments, and/or
documents processes of at least one instrument, in particular of all instruments, in particular also documents interventions, in particular manual interventions, in processes;
and/or monitors compliance with predefined or predefinable tolerances during the processes of at least one instrument, in particular of all instruments, and/or
monitors and/or documents changes, in particular of an instrument status, of work instructions/data, values, tolerances and/or other items of information and/or
counts and/or documents process repetitions, in particular with reference to the unique identification of the tool holder and/or of the tool, and/or
updates work instructions/data and/or
generates work instructions/data in the case of undesired states, in particular fault states and/or faulty or faultily implemented processes, and/or
generates a job list from the work instructions and in particular makes available or communicates the job list to the instruments of the processing environment to a machine in advance by the processing management system or be requested from the processing management system by the machine at the time of implementation) and/or
counts and documents processing processes, in particular those which are implemented on the instruments of the processing environment, in particular when creating the complete tool, and/or
communicates bidirectionally in or with the processing environment or with the instruments of the processing environment and/or
live tracks a status of instruments integrated into the environments;
checks the last implemented job(s) from a one-to-one identification (last result of the implemented job is displayed on the one-to-one identification—it can thus be ensured that all necessary steps have also been implemented.),
without any gaps records the history of the implemented work on the machines and documents the implemented work on the machines.

10. The method according to claim 1, which comprises communicating the work instructions or data via an interface selected from the group consisting of an OPC-UA interface, a client interface, and an MQTT interface.

11. The method according to claim 1, which comprises executing the method as a computer-implemented process.

12. The method according to claim 1, which comprises evaluating the data, including the work instructions and data or data generated by the instruments, by the processing management system.

13. A processing management system for data exchange during control of processing of a complete tool having a tool holder and a tool in an integrated and linked processing environment with at least one instrument for mounting the tool into the tool holder, the at least one instrument being selected from the group consisting of a shrink fit instrument, a balancing instrument, and a presetting instrument, in an automated and/or digitized manufacturing process for manufacturing a component using the complete tool with optionally further machines and automation components of an integrated manufacturing environment, the processing management system being configured in such a way that:
using processing data for processing the complete tool, in particular a tool list and/or device sheets, communicated by a superordinate manufacturing planning/control for manufacturing a component, work instructions or data are ascertainable; and
the work instructions or data are communicable to the instruments of the integrated and linked processing environment.

14. The processing management system according to claim 13, wherein the work data for the mounting instrument include at least one, or a plurality, or all of the following items of information:
type of the tool holder, in particular of the shrink fit chuck, (optionally also article number) and/or storage location of the tool holder, in particular of the shrink fit chuck,
unique identification, in particular number, of the tool holder, in particular of the shrink fit chuck,
type of the tool, in particular of the miller, and/or storage location of the tool, in particular of the miller,
unique identification, in particular number, of the tool, in particular of the miller, in particular in the case where the already used tool, in particular the miller, still has enough remaining running time, and/or of the tool holder, in particular of the shrink fit chuck,
number of identical tools required, in particular depending on a planned unit quantity of a component to be manufactured and a service life of the tool, in particular of the miller, in particular also taking account of a remaining running time in the case of used tools, in particular millers,
target length of the complete tool with tolerances,
allowance (optionally also to be adapted),
number of mounting cycles, in particular shrink fit cycles, of the tool holder, in particular of the shrink fit chuck.

15. The processing management system according to claim 13, wherein the work instructions for the mounting instrument include at least one, or a plurality, or all of the following items of information:
remove tool holder and/or tool in a predefined unit quantity from storage,
read a unique identification of the tool holder and/or of the tool;
automatically select shrink fit parameters and allowance;
display relevant shrink fit parameters/data,
drive length stop to a predefined or predefined length, either automatically or manually with user guidance on the mounting instrument;
display coarse setting;
upon approaching the target dimension display fine display;
heat tool holder;
insert tool;
pivot in length stop;
raise tool to length stop manually or with compression spring;
waiting time until tool is clamped;
cool tool holder;
monitor the cooling process;
control actual length with length stop;
store actual length in database;
identify the complete tool with the unique number of the tool holder;
if the tool holder is a mechanical clamping chuck, automatically display tool holder parameters to be used for technically proper mounting and also associated accessories for turning plate holders such as sliding blocks, mounting apparatuses, and also final representation of the complete tool for confirming the technically proper mounting together with length tolerances thereof.

16. The processing management system according to claim 13, wherein the work data for a presetting instrument include at least one, or a plurality, or all of the following items of information:
an item of geometry information, including a total length of the complete tool or a diameter of the tool, or a corner radius of the tool; and
a tool service life expressed in a number of components per new tool or a service life in minutes and hours.

17. The processing management system according to claim 13, wherein the work instructions for the presetting instrument include at least one, or a plurality, or all of the following items of information:
insert complete tool in measurement spindle,
optionally start an automatic measurement run or start a manual measurement, with predefined variables,
read actual dimensions into database and/or transmitting actual dimensions to processing management system; and
transmit presetting data to processing machines.

18. The processing management system according to claim 13, wherein the work data for the balancing instrument include at least one, or a plurality, or all of the following items of information:
balancing tolerance from database,
further parameters such as total length and total weight from database
measurement method;
balancing method, including unbalance compensation by material removal or material addition or adjustment of masses, and corresponding balancing planes where mass needs to be added or removed.

19. The processing management system according to claim 13, wherein the work instructions for the balancing instrument include at least one, or a plurality, or all of the following items of information:
clamp complete tool into balancing spindle,
measurement run according to predefined measurement method;
unbalance compensation according to predefined method;
checking the balancing accuracy by way of a test run, reading actual unbalance into database;
transmit result to processing management system;
optionally repeat process until result is okay and traceable in the processing management system.

20. The processing management system according to claim 13, wherein the processing management system is configured to enable at least one of the following:
a status of at least one instrument or of all instruments is monitorable; and/or
processes of at least one instrument or of all instruments are documentable, including interventions in processes are documentable; and/or
compliance with predefined or predefinable tolerances during the processes of at least one instrument or of all instruments is monitorable; and/or
changes of an instrument status, of work instructions or data, values, tolerances and/or other items of information, are monitorable and/or documentable; and/or
process repetitions are countable and/or documentable, in particular with reference to the unique identification of the tool holder and/or of the tool, and/or
work instructions and work data are updatable; and/or
work instructions and work data are generable in the case of undesired states, in particular fault states and/or faulty or faultily implemented processes; and/or
a job list is generatable from the work instructions and in particular the job list is able to be made available or communicable to the instruments of the processing environment to a machine in advance by the processing management system or be requested from the processing management system by the machine at the time of implementation; and/or
processing processes, in particular those which are implemented on the instruments of the processing environment, when creating the complete tool, are implementable, countable and documentable; and/or
bidirectional communication in or with the processing environment or with the instruments of the processing environment is possible; and/or
a status of instruments integrated into the environments is trackable in realtime;
a last-implemented job is checkable from a one-to-one identification, in that last result of the implemented job is displayed on the one-to-one identification and ensures that all necessary steps have also been implemented;
without any gaps the history of the implemented work on the machines is recordable and the implemented work on the machines is documentable.

21. The processing management system according to claim 13, configured to evaluate data, including at least one of work instructions, work data, or data generated by the instruments.

22. An apparatus for data processing, comprising a plurality of devices configured for executing the method according to claim 1.

23. A non-transitory computer program, comprising instructions which, when the program is executed by a computer, cause the computer to execute the method according to claim 1.

24. A non-transitory computer-readable medium, comprising instructions which, upon execution by a computer, cause the computer to execute the method according to claim 1.
